(19) United States
(12) Patent Application Publication
(10) Pub. No.: US 2015/0243966 A1
(43) Pub. Date: Aug. 27, 2015

(54) POSITIVE ELECTRODE FOR NON-AQUEOUS ELECTROLYTE SECONDARY BATTERY AND NON-AQUEOUS ELECTROLYTE SECONDARY BATTERY

(71) Applicant: Panasonic Corporation, Osaka (JP)

(72) Inventors: KAZUKI ENDO, Osaka (JP); HIROSHI KAWADA, Osaka (JP); MASAHIRO KINOSHITA, Osaka (JP)

(21) Appl. No.: 14/623,212

(22) Filed: Feb. 16, 2015

(30) Foreign Application Priority Data
Feb. 27, 2014 (JP) 2014-036326

(51) Int. Cl. H01M 4/131; H01M 10/05

(52) U.S. Cl. CPC H01M 4/131; H01M 10/05; H01M 2004/028

(57) ABSTRACT

A positive electrode for a non-aqueous electrolyte secondary battery includes a positive electrode active material layer which contains a first positive electrode active material including a Li₂MnO₃-LiMO₂ solid solution and a second positive electrode active material including LiₐM*O₂ and in which the ratio of the weight of the first positive electrode active material per unit thickness to the total weight of the first positive electrode active material and the second positive electrode active material is higher in the vicinity of the surface of the positive electrode active material layer than that in the vicinity of the interface between the positive electrode active material layer and a current collector.

### BACKGROUND

1. Technical Field

The present disclosure relates to positive electrodes for non-aqueous electrolyte secondary batteries and non-aqueous electrolyte secondary batteries using the same.

2. Description of the Related Art

Non-aqueous electrolyte secondary batteries are desired to have higher capacity and high safety.

Lithium-rich transition metal oxides typified by Li₂MnO₃(Li[Li_{1/3}Mn_{2/3}]O₂) and solid solutions thereof are receiving attention as a high-capacity positive electrode material because Li is also included in transition metal layers other than Li layers, and thus the amount of Li participating in charge/discharge is large (for example, refer to U.S. Pat. No. 6,677,082).

### SUMMARY

However, in the related art, positive electrodes are not satisfactory in terms of energy density and safety.

One non-limiting and exemplary embodiment provides a positive electrode for a non-aqueous electrolyte secondary battery having a high energy density and excellent safety, and a non-aqueous electrolyte secondary battery.

In one general aspect, the techniques disclosed here feature a positive electrode for a non-aqueous electrolyte secondary battery including a current collector and a positive electrode active material layer, an electroconductive material, and a binder provided on the current collector, in which the positive electrode active material layer contains a first positive electrode active material including a Li₂MnO₃—LiMO₂ solid solution (where M is at least one selected from the group consisting of Ni, Co, Fe, Al, Mg, Ti, Sn, Zr, Nb, Mo, W, and Bi) and a second positive electrode active material including LiₐM*O₂ (where 0.1≦a≦1.1, and M* is at least one selected from the group consisting of Ni, Co, Fe, Al, Mg, Ti, Sn, Zr, Nb, Mo, W, and Bi); and in which the ratio of the weight of the first positive electrode active material per unit thickness to the total weight of the first positive electrode active material and the second positive electrode active material is higher in the vicinity of the surface of the positive electrode active material layer than that in the vicinity of the interface between the positive electrode active material layer and the current collector.

In accordance with the present disclosure, it is possible to provide a positive electrode for a non-aqueous electrolyte secondary battery having a high energy density and excellent safety, and a non-aqueous electrolyte secondary battery.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view showing a positive electrode active material in an example of an exemplary embodiment of the present disclosure; and

FIG. 2 is a perspective view showing a non-aqueous electrolyte secondary battery, which is longitudinally cut out, in an example of an exemplary embodiment of the present disclosure.

### DETAILED DESCRIPTION

### (Underlying Knowledge Forming Basis of the Present Disclosure)

In the related art described above, since the lithium-rich transition metal oxide used for a positive electrode active material has a low electronic conductive property, it may be necessary to use a large amount of an electroconductive material when the lithium-rich transition metal oxide is used for an electrode, and it may be difficult to increase the density of the active material in the electrode.

Furthermore, in a known technique for increasing the density of such an active material, a lithium-rich positive electrode active material and an existing lithium composite transition metal oxide are mixed. However, t is difficult to secure sufficient safety by using this technique alone.

In an aspect of the present disclosure, a positive electrode for a non-aqueous electrolyte secondary battery includes a current collector and a positive electrode active material layer, an electroconductive material, and a binder provided on the current collector, in which the positive electrode active material layer contains a first positive electrode active material including a Li₂MnO₃—LiMO₂ solid solution (where M is at least one selected from the group consisting of Ni, Co, Fe, Al, Mg, Ti, Sn, Zr, Nb, Mo, W, and Bi) and a second positive electrode active material including LiₐM*O₂ (where 0.1≦a≦1.1, and M* is at least one selected from the group consisting of Ni, Co, Fe, Al, Mg, Ti, Sn, Zr, Nb, Mo, W, and Bi); and in which the ratio of the weight of the first positive electrode active material per unit thickness to the total weight of the first positive electrode active material and the second positive electrode active material is higher in the vicinity of the surface of the positive electrode active material layer than that in the vicinity of the interface between the positive electrode active material layer and the current collector. For example, the first positive electrode active material may mainly include a Li₂MnO₃-LiMO₂ solid solution (where M is at least one selected from the group consisting of Ni, Co, Fe, Al, Mg, Ti, Sn, Zr, Nb, Mo, W, and Bi).

Thereby, it is possible to provide a positive electrode for a non-aqueous electrolyte secondary battery having a high energy density and excellent safety.

Exemplary embodiments of the present disclosure will be described in detail below.

In an example of an exemplary embodiment of the present disclosure, a non-aqueous electrolyte secondary battery includes a positive electrode, a negative electrode, and a non-aqueous electrolyte including a non-aqueous solvent. Furthermore, for example, a separator may be provided between the positive electrode and the negative electrode. The non-aqueous electrolyte secondary battery, for example, has a structure in which an electrode body formed by winding the positive electrode and the negative electrode with the separator therebetween and the non-aqueous electrolyte are contained in a case.

The end-of-charge voltage is not particularly limited, but is, for example, 4.4 V or more, 4.5 V or more, and 4.55 to 5.0 V. The non-aqueous electrolyte secondary battery according to the present disclosure is particularly suitable in high voltage application with an end-of-charge voltage of 4.4 V or more.

### (Positive Electrode)

A positive electrode 10, for example, includes a positive electrode current collector 13 made of a metal foil or the like and a positive electrode active material layer disposed on the positive electrode current collector 13. As the positive electrode current collector 13, a foil of a metal, such as aluminum, that is stable in the positive electrode potential range, a film having a surface layer including a metal, such as aluminum, that is stable in the positive electrode potential range, or the like may be used. The positive electrode active material layer desirably includes, in addition to a positive electrode active material, an electroconductive material 23, and a binder 24.

The positive electrode active material layer contains at least two active materials (a first positive electrode active material 21 and a second positive electrode active material 22). The first positive electrode active material 21 is a lithium-containing transition metal oxide (lithium-rich positive electrode active material) represented by a Li₂MnO₃—LiMO₂ solid solution (where M is at least one selected from the group consisting of Ni, Co, Fe, Al, Mg, Ti, Sn, Zr, Nb, Mo, W, and Bi). The second positive electrode active material 22 is a lithium-containing transition metal oxide having a layered structure.

The positive electrode active material layer is formed such that the ratio of the weight of the first positive electrode active material 21 per unit thickness to the total weight of the first positive electrode active material 21 and the second positive electrode active material 22 is higher in the vicinity of the surface of the positive electrode active material layer than that in the vicinity of the interface between the positive electrode active material layer and the current collector. In such a manner, a layer with a high resistance is formed on the surface of the material layer. Therefore, even in the case where a piece of foreign matter, such as a nail, causes a short circuit between positive and negative electrodes, a current flowing to the short-circuit point is suppressed. Thus, it is possible to enhance safety against an internal short circuit. On the other hand, in the vicinity of the interface with the current collector, since the ratio of the second active material having a relatively high electronic conductive property is high, a decrease in capacity due to insufficient current collection is unlikely to occur, and it is possible to obtain a high capacity.

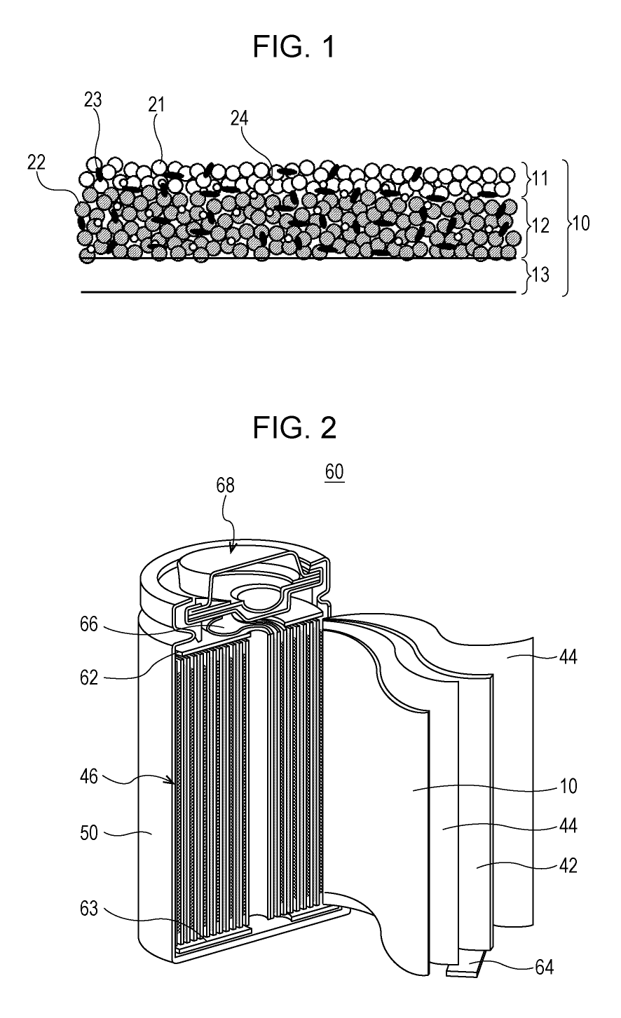

A typical example of such an embodiment is shown in FIG. 1, in which a positive electrode active material layer includes a first positive electrode active material layer 11 mainly including a first positive electrode active material 21 and a second positive electrode active material layer 12 mainly including a second positive electrode active material 22.

By employing the two-layered structure, it is possible to easily obtain the effects of improving safety and improving collectivity. In this case, the thickness of the first positive electrode active material layer is, for example, 3 to 50 μm. When the thickness is less than 3 μm, formation of the active material layer becomes difficult from the viewpoint of processing. When the thickness is more than 50 μm, a decrease in capacity due to insufficient current collection is likely to occur. Furthermore, the thickness ratio of the first positive electrode active material layer 11 and the second positive electrode active material layer 12 is, for example, 1:10 to 5:5. By setting the thickness ratio in the range described above, both high capacity and high safety can be easily achieved.

The first positive electrode active material 21 is a lithium-rich lithium-containing transition metal oxide in which Li is also included in transition metal layers other than Li layers. In the powder X-ray diffraction pattern of the oxide, peaks attributable to a superlattice structure are observed in the vicinity of 2θ of 20° to 25°. Specifically, the first positive electrode active material 21 is desirably a lithium-containing transition metal oxide represented by general formula: Li₁₊ₐ(Mn_{b}M_{1-b})₁₋ₐO_{2+c}{0.1≦a≦0.33, 0.5≦b≦1.0, −0.1≦c≦0.1} in the discharged state or in the unreacted state.

The first positive electrode active material 21 is desirably a Li₂MnO₃-LiMO₂ solid solution containing Ni and Co as M, and examples thereof include Li_{1.2}Ni_{0.13}Co_{0.13}Mn_{0.13}O₂, Li_{1.13}Ni_{0.63}Co_{0.12}Mn_{0.12}O₂, and the like. In the first positive electrode active material, by satisfying the relationship 0.1≦a≦0.33, it is believed that structural stability is improved and stable charge/discharge characteristics can be achieved. Furthermore, by satisfying the relationship 0.5≦b≦1.0, a higher capacity can be achieved.

As described above, the second positive electrode active material 22 is a lithium-containing transition metal oxide having a layered structure in which the ratio of Ni relative to the total number of moles of metal elements excluding Li is 50 mole percent or more. Specifically, the second positive electrode active material 22 is desirably a lithium-containing transition metal oxide represented by general formula: LiₐM*O₂ (where 0.1≦a≦1.1, and M* is at least one selected from the group consisting of Ni, Co, Fe, Al, Mg, Ti, Sn, Zr, Nb, Mo, W, and Bi) in the discharged state or in the unreacted state.

The second positive electrode active material 22 is desirably a lithium-containing transition metal oxide containing, in addition to Ni, Co and Mn as transition metals, and examples thereof include LiNi_{0.5}Co_{0.2}Mn_{0.3}O₂, LiNi_{0.6}Co_{0.2}Mn_{0.2}O₂, LiNi_{0.5}Mn_{0.5}O₂, LiNi_{0.80}Co_{0.15}Al_{0.05}O₂, and the like.

The content of the first positive electrode active material 21 is, for example, 10% to 90% by weight, for example, 20% to 50% by weight, relative to the total weight of the positive electrode active material. The content of the second positive electrode active material is, for example, 10% to 90% by weight, for example, 50% to 80% by weight, relative to the total weight of the positive electrode active material. By setting the contents of the two materials to the ranges described above, it is possible to achieve both a higher capacity and high durability. The positive electrode active material is, for example, obtained by mixing the first positive electrode active material 21 and the second positive electrode active material 22 at a weight ratio of 1:1.

The positive electrode active material may contain other metal oxides and the like in the form of mixture or solid solution within the range that does not impair benefits of the present disclosure. Furthermore, the surface of the positive electrode active material may be covered with fine particles of a metal oxide, such as aluminum oxide (Al₂O₃), a metal fluoride, such as aluminum fluoride (AlF₃), or an inorganic compound, such as a phosphate compound or a boric compound.

The electroconductive material 23 is used to enhance the electric conductivity of the positive electrode active material layer. Carbon materials are can be used as the electroconductive material 23. For example, carbon black, acetylene black, Ketjen black, and graphite can be used as the electroconductive material 23. These may be used alone or in combination of two or more.

The content of the electroconductive material 23 is, for example, 2% by weight or less. Generally, since a lithium-rich positive electrode active material has a high powder resistance, in order to extract the capacity of the positive electrode active material, a larger amount of the electroconductive material 23 is added. However, in the positive electrode according to the exemplary embodiment of the present disclosure, by using the second positive electrode active material together with the first positive electrode active material, the capacity can be extracted with a smaller amount than before. Furthermore, since a layer with a higher resistance is formed on the surface of the active material layer as described above, the safety effect is enhanced.

Furthermore, the density of the active material in the electrode can be increased by reducing the amount of the electroconductive material 23.

The binder 24 is used in order to maintain the good contact state between the positive electrode active material and the electroconductive material 23 and to enhance the binding property of the positive electrode active material and the like with respect to the surface of the positive electrode current collector. Examples of the binder include polytetrafluoroethylene (PTFE), polyvinylidene fluoride (PVDF), and their modified forms. The binder 24 may be used together with a thickener, such as carboxymethyl cellulose (CMC) or polyethylene oxide (PEO). These may be used alone or in combination of two or more.

### (Negative Electrode)

A negative electrode, for example, includes a negative electrode current collector made of a metal foil or the like and a negative electrode active material layer disposed on the negative electrode current collector. As the negative electrode current collector, a foil of a metal, such as copper, that is stable in the negative electrode potential range, a film having a surface layer including a metal, such as copper, that is stable in the negative electrode potential range, or the like may be used. The negative electrode active material layer desirably includes a binder, in addition to a negative electrode active material that can occlude and release lithium ions. As the binder, PTFE or the like can be used as is the case of the positive electrode, but it is desirable to use a styrene-butadiene copolymer (SBR), a modified form thereof, or the like. The binder may be used together with a thickener, such as CMC.

Examples of the negative electrode active material that can be used include natural graphite, artificial graphite, lithium, silicon, carbon, tin, germanium, aluminum, lead, indium, gallium, lithium alloys, carbon and silicon in which lithium has been occluded in advance, and alloys and mixtures thereof.

### (Non-Aqueous Electrolyte)

A non-aqueous electrolyte includes a non-aqueous solvent and an electrolyte salt dissolved in the non-aqueous solvent.

Examples of the non-aqueous solvent that can be used include cyclic carbonates, chain-like carbonates, nitriles, and amides. Exar spies of cyclic carbonates include cyclic carbonic acid esters, cyclic carboxylic acid esters, and cyclic esters. Examples of chain-like carbonates include chain esters and chain ethers. More specifically, as the cyclic carbonic acid ester, ethylene carbonate (EC) or the like can be used. As the cyclic carboxylic acid ester, γ-butyrolactone (γ-GBL) or the like can be used. As the chain ester, ethyl methyl carbonate (EMC), dimethyl carbonate (DMC), or the like can be used. Furthermore, a halogen substitution product in which a hydrogen atom of the non-aqueous solvent is substituted with a halogen atom, such as a fluorine atom, can also be used.

In particular, in order to increase the voltage to 4.4 V or more, a mixed solvent of 4-fluoroethylene carbonate and methyl 3,3,3-trifluoropropionate is desirable.

The electrolyte salt is, for example, a lithium salt. As the lithium salt, any supporting salt generally used in existing non-aqueous electrolyte secondary batteries may be used. Specific examples thereof include LiPF₆, LiBF₄, LiAsF₆, LiClO₄, LiCF₃SO₃, LiN(FSO₂)₂, LiN(C₁F₂ₗ₊₁SO₂)(CₘF₂ₘ₊₁SO₂) (where l and m are each an integer of 1 or more), LiC(CₚF₂ₚ₊₁SO₂)(C_{q}F_{2q+1}SO₂)(CᵣF₂ᵣ₊₁SO₂) (where p, q, and r are each an integer of 1 or more), Li[B(C₂O₄)₂] (lithium bis(oxalate)borate (LiBOB)), Li[B(C₂O₄)F₂], Li[P(C₂O₄)F₄], and Li[P(C₂O₄)₂F₂]. These lithium salts may be used alone or in combination of two or more.

Furthermore, optionally, an additive may be incorporated thereinto. As the additive, vinylene carbonate (VC), ethylene sulfite (ES), cyclohexylbenzene (CHB), or a modified form thereof can be used. The additives may be used alone or in combination of two or more. The percentage of the additive in the non-aqueous electrolyte is not particularly limited, but is, for example, about 0.05% to 10% by mass relative to the total amount of the non-aqueous electrolyte.

### (Separator)

As a separator, a porous sheet having ion permeability and an insulating property is used. Specific examples of the porous sheet include a microporous thin film, woven fabric, and non-woven fabric. The material for the separator may be cellulose or an olefin resin, such as polyethylene or polypropylene. The separator may be a multi-layer film including a cellulose fiber layer and a fiber layer made of a thermoplastic resin, such as an olefin resin.

### Example 1

### Fabrication of Positive Electrode

Each of a first positive electrode active material and a second positive electrode active material (97.5% by mass), acetylene black (1% by mass), and polyvinylidene fluoride (1.5% by mass) were mixed, and the resulting mixture was kneaded together with N-methyl-2-pyrrolidone to form a slurry. Thereby, a first slurry mainly including the first positive electrode active material and a second slurry mainly including the second positive electrode active material were obtained. Subsequently, the second slurry was applied onto an aluminum foil current collector, i.e., a positive electrode current collector, and the first slurry was applied thereonto before the second slurry became dry, followed by drying. After both surfaces of the positive electrode current collector were applied with the active material and dried, rolling was performed to produce a positive electrode with each layer having a thickness of about 50 μm. The average density of the active material in the active material layer after rolling was 3.3 g/cm³. As the positive electrode active materials, Li_{1.2}Mn_{0.54}Ni_{0.13} Co_{0.13}O₂ (hereinafter referred to as the “first positive electrode active material”) and LiNi_{0.5}Co_{0.2}Mn_{0.3}O₂ (hereinafter referred to as the “second positive electrode active material”) were used. The thickness ratio of the first positive electrode active material layer mainly including the first positive electrode active material and the second positive electrode active material layer mainly including the second positive electrode active material was set to be 1:1.

### (Synthesis of First Positive Electrode Active Material)

By mixing and coprecipitating manganese sulfate (MnSO₄), nickel sulfate (NiSO₄), and cobalt sulfate (CoSO₄) in an aqueous solution, (Mn,N,Co)(OH)₂, which was a precursor, was obtained. Subsequently, the precursor and lithium hydroxide monohydrate (LiOH.H₂O) were mixed, and the resulting mixture was calcined at 850° C. for 12 hours. Thereby, the first positive electrode active material was obtained.

### (Synthesis of Second Positive Electrode Active Material)

Lithium sulfate (LiNO₃), nickel oxide (IV) (NiO₂), cobalt oxide (II,III) (Co₃O₄), and manganese oxide (III) (Mn₂O₃) were mixed, and the resulting mixture was calcined at a calcination temperature of 700° C. for 10 hours. Thereby, the second positive electrode active material was obtained.

### Fabrication of Negative Electrode

Graphite (98% by mass), a sodium salt of carboxymethyl cellulose (1% by mass), and a styrene-butadiene copolymer (1% by mass) were mixed, and the resulting mixture was kneaded together with water to form a slurry. Subsequently, the resulting slurry was applied onto a copper foil current collector, i.e., a negative electrode current collector, followed by drying and rolling to produce a negative electrode.

### Production of Non-Aqueous Electrolyte

4-Fluoroethylene carbonate and methyl 3,3,3-trifluoropropionate were prepared in a volume ratio of 1:3, and 1.0 mol/l of LiPF₆ was added to the resulting solvent. Thereby, a non-aqueous electrolyte was produced.

### Fabrication of Cylindrical Type Non-Aqueous Electrolyte Secondary Battery

Using the positive electrode, the negative electrode, and the non-aqueous electrolyte thus produced, a cylindrical type non-aqueous electrolyte secondary battery (hereinafter referred to as the cylindrical type battery′) was fabricated by the method described below. As a separator, a microporous film made of polypropylene was used. FIG. 2 is a perspective view showing a cylindrical type battery 60, which is longitudinally cut out. A positive electrode 10 produced as described above was cut to a size with a short side of 55 mm and a long side of 450 rm. A positive electrode current collector tab 66 including aluminum was formed in the central portion in the long side direction of the positive electrode 10. Furthermore, a negative electrode 42 was cut to a size with a short side of 57 mm and a long side of 550 mm, and a negative electrode current collector tab 64 including copper was formed on the outer peripheral edge in the long side direction of the negative electrode 42.

The positive electrode 10 and the negative electrode 42 were wound with a separator 44 having a three-layered structure of PP/PE/PP therebetween to form a wound electrode body 46. Next, insulators 62 and 63 were disposed on the upper and lower parts of the wound electrode body 46, respectively. The wound electrode body 46 was placed inside a cylindrical battery package can 50 made of steel with a diameter of 18 mm and a height of 65 mm in which the wound electrode body 46 also served as a negative electrode terminal. Two negative electrode current collector tabs 64 of the negative electrode 42 were welded to the inner bottom of the battery package can 50, and the positive electrode current collector tab 66 of the positive electrode 10 was welded to the bottom plate portion of a current breaking sealing body 68 provided with a safety valve and a current breaker. The non-aqueous electrolyte was supplied from an opening of the battery package can 50, and then, the battery package can 50 was sealed with the current breaking sealing body 68. Thus, a cylindrical type battery 60 was obtained.

### Comparative Example 1

A cylindrical type battery used in Comparative Example 1 was fabricated as in Example 1 except that, using only the first slurry formed in Example 1, application was performed by a doctor blade method onto both surfaces of a positive electrode current collector 13, followed by drying and rolling, and thus an active material layer with a thickness of about 50 μm (density of the active material after rolling: 3.0 g/cm³) was formed on each of both surfaces of the positive electrode current collector 13.

### Comparative Example 2

A cylindrical type battery used in Comparative Example 2 was fabricated as in Comparative Example 1 except that the first slurry in Example 1 was prepared at a mixing ratio of 92% by mass of the positive electrode active material, 5% by mass of acetylene black, and 3% by mass of polyvinylidene fluoride, and the active material layer was formed with a thickness of about 60 μm (density of the active material after rolling: 2.6 g/cm³) on each of both surfaces of the positive electrode current collector 13.

### Comparative Example 3

A cylindrical type battery used in Comparative Example 3 was fabricated as in Comparative Example 1 except that the first positive electrode active material and the second positive electrode active material were used at the ratio of 1:1, the positive electrode active material (97.5% by mass), acetylene black (1% by mass), and polyvinylidene fluoride (1.5% by mass) were mixed, and using a mixed slurry obtained by kneading the mixture together with N-methyl-2-pyrrolidone, the active material layer was formed with a thickness of about 50 (density of the active material after rolling: 3.3 g/cm³) on each of both surfaces of the positive electrode current collector 13.

### Comparative Example 4

A cylindrical type battery used in Comparative Example 4 was fabricated as in Example 1 except that, using only the second slurry formed in Example 1, application was performed by a doctor blade method onto both surfaces of a positive electrode current collector 13, followed by drying, and thus an active material layer with a thickness of about 55 μm (density of the active material after rolling: 3.5 g/cm³) was formed on each of both surfaces of the positive electrode current collector 13.

### Evaluation of Discharge Capacity

In order to evaluate the discharge capacity of Example 1 and Comparative Examples 1 to 4, a charge/discharge test was conducted at an ambient temperature of 25° C. The test was conducted in the following manner. Each of the cylindrical type batteries of Example 1 and Comparative Examples 1 to 4 was charged at a constant current of 0.2 C (340 mA) until the battery voltage reached 4.6V, and then charging was continued at a constant voltage until the current value reached 0.03 C (50 mA). Next, discharging was performed at a constant current of 0.2 C (340 mA) until the battery voltage reached 2.0 V, and discharging was further performed at a constant current of 0.1 C (170 mA) until the battery voltage reached 2.0 V. Table shows the sum of the discharge capacity per unit volume of the positive electrode active material layer at 0.2 C and 0.1 C.

### Nail Insertion Test

In order to evaluate safety, a nail insertion test was conducted on each of the cylindrical type batteries of Example 1 and Comparative Examples 1 to 4 in the fully charged state. The test was conducted in the following manner: first, each of the cylindrical type batteries of Example 1 and Comparative Examples 1 to 4 was charged at an ambient temperature of 25° C., at a constant current of 0.2 C (340 mA) until the battery voltage reached 4.6 V, and then charging was continued at a constant voltage until the current value reached 0.03 C (50 mA). Next, under the environment at a battery temperature of 25° C., the pointed tip of a round nail with a diameter of 3 mm was brought into contact with the central portion of the side surface of each of the cylindrical type batteries of Example 1 and Comparative Examples 1 to 4, the round nail was inserted, in the diametrical direction, into each of the cylindrical type batteries at a speed of 10 mm/sec, and insertion of the round nail was stopped at the time when the round nail completely passed through each of the cylindrical type batteries. The battery temperature after the insertion was measured by bringing a thermocouple into contact with the surface of the battery. The battery temperature 30 seconds after the insertion was evaluated. The results of the battery temperature are shown in Table.

TABLE

| | Discharge capacity | Temperature after nail |
|---|---|---|
| | (mAh/cm³) | insertion test (° C.) |
| Example 1 | 705 | 90 |
| Comparative Example 1 | 470 | 100 |
| Comparative Example 2 | 676 | 150 |
| Comparative Example 3 | 700 | 145 |
| Comparative Example 4 | 680 | 140 |

As is clear from the results shown in Table, in Example 1, the discharge capacity is higher and the battery temperature after the nail insertion test is lower compared with Comparative Example 3.

Furthermore, as is evident from the results of Comparative Example 1 and Comparative Example 2, regarding the lithium-rich positive electrode active material, in order to extract the discharge capacity, a larger amount of an electroconductive material is needed than in the case of the lithium-containing transition metal oxide having an ordinary layered structure (refer to Comparative Example 4). In contrast, in Example 1, it has been confirmed that the discharge capacity can be increased using a small amount of an electroconductive material.

As described above, in a positive electrode for a non-aqueous electrolyte secondary battery in which the positive electrode active material layer contains a lithium-rich positive electrode active material and a lithium-containing transition metal oxide having a layered structure, and in which the percentage of the lithium-rich positive electrode active material is increased in the vicinity of the surface of the positive electrode active material layer, and a non-aqueous electrolyte secondary battery including the positive electrode for a non-aqueous electrolyte secondary battery, the discharge capacity is high, and it is possible to suppress heat generation of the battery at the time of an internal short circuit due to nail insertion or the like.

Positive electrodes for non-aqueous electrolyte secondary batteries and non-aqueous electrolyte secondary batteries using the same according to the present disclosure can be used, for example, for power sources of cellular phones, notebook computers, smartphones, tablets, electric vehicles (EVs), hybrid electric vehicles (HEVs, PHEVs), power tools, and the like in which, in particular, a high energy density is required.

What is claimed is:

1. A positive electrode for a non-aqueous electrolyte secondary battery comprising:
a current collector; and
a positive electrode active material layer, an electroconductive material, and a binder provided on the current collector,
wherein the positive electrode active material layer contains a first positive electrode active material including a Li₂MnO₃-LiMO₂ solid solution (where M is at least one selected from the group consisting of Ni, Co, Fe, Al, Mg, Ti, Sn, Zr, Nb, Mo, W, and Bi) and a second positive electrode active material including LiₐM*O₂ (where 0.1≦a≦1.1, and M* is at least one selected from the group consisting of Ni, Co, Fe, Al, Mg, Ti, Sn, Zr, Nb, Mo, W, and Bi); and
wherein the ratio of the weight of the first positive electrode active material per unit thickness to the total weight of the first positive electrode active material and the second positive electrode active material is higher in the vicinity of the surface of the positive electrode active material layer than that in the vicinity of the interface between the positive electrode active material layer and the current collector.

2. The positive electrode for a non-aqueous electrolyte secondary battery according to claim 1, wherein the content of the electroconductive material in the positive electrode active material layer is 2% by weight or less.

3. The positive electrode for a non-aqueous electrolyte secondary battery according to claim 1, wherein the positive electrode active material layer includes:
a first positive electrode active material layer including the first positive electrode active material; and
a second positive electrode active material layer including the second positive electrode active material and which is disposed on the first positive electrode active material layer.

4. The positive electrode for a non-aqueous electrolyte secondary battery according to claim 1, wherein a first active material layer has a thickness of 3 to 50 μm.

5. A non-aqueous electrolyte secondary battery comprising:
the positive electrode including a current collector, a positive electrode active material layer, an electroconductive material, and a binder provided on the current collector;
a negative electrode; and
an electrolyte,
wherein the positive electrode active material layer contains a first positive electrode active material including a Li₂MnO₃—LiMO₂ solid solution (where M is at least one selected from the group consisting of Ni, Co, Fe, Al, Mg, Ti, Sn, Zr, Nb, Mo, W, and Bi) and a second positive electrode active material including LiₐM*O₂ (where 0.1≦a≦1.1, and M* is at least one selected from the group consisting of Ni, Co, Fe, Al, Mg, Ti, Sn, Zr, Nb, Mo, W, and Si); and
wherein the ratio of the weight of the first positive electrode active material per unit thickness to the total weight of the first positive electrode active material and the second positive electrode active material is higher in the vicinity of the surface of the positive electrode active material layer than that in the vicinity of the interface between the positive electrode active material layer and the current collector.
